(19) United States
(12) Patent Application Publication
(10) Pub. No.: US 2014/0068064 A1
(43) Pub. Date: Mar. 6, 2014

(54) METHOD FOR QOS MANAGEMENT IN HOME AND ROAMING SCENARIOS BASED ON LOCATION/APP SERVER ASSISTANCE

(71) Applicant: QUALCOMM Incorporated, San Diego, CA (US)

(72) Inventors: Kirankumar ANCHAN, San Diego, CA (US); Karthika PALADUGU, San Diego, CA (US); Arvind V. SANTHANAM, San Diego, CA (US)

(73) Assignee: QUALCOMM Incorporated, San Diego, CA (US)

(21) Appl. No.: 14/012,947

(22) Filed: Aug. 28, 2013

Related U.S. Application Data
(60) Provisional application No. 61/695,750, filed on Aug. 31, 2012.

(51) Int. Cl. H04L 12/927

(52) U.S. Cl. CPC H04L 47/805
USPC 709/224

(57) ABSTRACT

The disclosure is related to managing, at an application server, a quality of service (QoS) provided for an application executing on a client device. An aspect receives, from the client device, an identifier of a first network servicing the client device, determines a QoS of a supplemental link established by a second network for the application, determines whether or not the QoS of the supplemental link meets requirements of the application, and determines whether or not the first network is able to support an alternative acceptable QoS when the QoS of the supplemental link does not meet the requirements of the application.

### CLAIM OF PRIORITY UNDER 35 U.S.C. §119

The present application for patent claims priority to Provisional Application No. 61/695,750, entitled “METHOD FOR QOS MANAGEMENT IN HOME AND ROAMING SCENARIOS BASED ON LOCATION/APP SERVER ASSISTANCE,” filed Aug. 31, 2012, and assigned to the assignee hereof and hereby expressly incorporated by reference herein.

### BACKGROUND

1. Field of the Invention

Embodiments of the invention relate to quality of service (QoS) management in home and roaming scenarios based on location or application server assistance.

2. Description of the Related Art

Wireless communication systems have developed through various generations, including a first-generation analog wireless phone service (1G), a second-generation (2G) digital wireless phone service (including interim 2.5G and 2.75G networks) and third-generation (3G) and fourth-generation (4G) high speed data/Internet-capable wireless services. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, and newer hybrid digital communication systems using both TDMA and CDMA technologies.

More recently, Long Term Evolution (LTE) has been developed as a wireless communications protocol for wireless communication of high-speed data for mobile phones and other data terminals. LTE is based on GSM, and includes contributions from various GSM-related protocols such as Enhanced Data rates for GSM Evolution (EDGE), and Universal Mobile Telecommunications System (UMTS) protocols such as High-Speed Packet Access (HSPA).

Home-terminated, network-initiated quality of service (QoS) can result in suboptimal behavior. 3rd Generation Partnership Project (3GPP) networks support home-terminated bearers for users roaming onto visited networks. A high priority guaranteed bit rate (GBR) application requires a higher QoS, which is provided in the home network of operation. However, a visited network may not provide the requisite QoS for such an application.

Specifically, when a network-initiated QoS is provided to a user equipment (UE) on a separate dedicated bearer for an access point name (APN), the core network may allocate resources that the radio access network (RAN) in the visited network may not support. The visited RAN may therefore downgrade the QoS on the dedicated bearer. In that case, the UE has a dedicated bearer without the requisite QoS, which is a waste of resources on the network and the UE, as the UE could otherwise leverage the existing default bearer when the QoS is not available on the dedicated bearer.

### SUMMARY

The disclosure is related to managing a quality of service (QoS) provided for an application executing on a client device. A method for managing, at an application server, a QoS provided for an application executing on a client device includes receiving, from the client device, an identifier of a first network servicing the client device, determining a QoS of a supplemental link established by a second network for the application, determining whether or not the QoS of the supplemental link meets requirements of the application, and determining whether or not the first network is able to support an alternative acceptable QoS when the QoS of the supplemental link does not meet the requirements of the application.

An apparatus for managing, at an application server, a QoS provided for an application executing on a client device includes logic configured to receive, from the client device, an identifier of a first network servicing the client device, logic configured to determine a QoS of a supplemental link established by a second network for the application, logic configured to determine whether or not the QoS of the supplemental link meets requirements of the application, and logic configured to determine whether or not the first network is able to support an alternative acceptable QoS when the QoS of the supplemental link does not meet the requirements of the application.

An apparatus for managing, at an application server, a QoS provided for an application executing on a client device includes means for receiving, from the client device, an identifier of a first network servicing the client device, means for determining a QoS of a supplemental link established by a second network for the application, means for determining whether or not the QoS of the supplemental link meets requirements of the application, and means for determining whether or not the first network is able to support an alternative acceptable QoS when the QoS of the supplemental link does not meet the requirements of the application.

A non-transitory computer-readable medium for managing, at an application server, a QoS provided for an application executing on a client device includes at least one instruction to receive, from the client device, an identifier of a first network servicing the client device, at least one instruction to determine a QoS of a supplemental link established by a second network for the application, at least one instruction to determine whether or not the QoS of the supplemental link meets requirements of the application, and at least one instruction to determine whether or not the first network is able to support an alternative acceptable QoS when the QoS of the supplemental link does not meet the requirements of the application.

### BRIEF DESCRIPTION OF THE DRAWINGS

A more complete appreciation of embodiments of the invention and many of the attendant advantages thereof will be readily obtained as the same becomes better understood by reference to the following detailed description when considered in connection with the accompanying drawings which are presented solely for illustration and not limitation of the invention, and in which:

FIG. 1 illustrates a high-level system architecture of a wireless communications system in accordance with an embodiment of the invention.

FIG. 2A illustrates an example configuration of a radio access network (RAN) and a packet-switched portion of a core network for a 1x EV-DO network in accordance with an embodiment of the invention.

FIG. 2B illustrates an example configuration of the RAN and a packet-switched portion of a General Packet Radio Service (GPRS) core network within a 3G UMTS W-CDMA system in accordance with an embodiment of the invention.

FIG. 2C illustrates another example configuration of the RAN and a packet-switched portion of a GPRS core network within a 3G UMTS W-CDMA system in accordance with an embodiment of the invention.

FIG. 2D illustrates an example configuration of the RAN and a packet-switched portion of the core network that is based on an Evolved Packet System (EPS) or Long Term Evolution (LTE) network in accordance with an embodiment of the invention.

FIG. 2E illustrates an example configuration of an enhanced High Rate Packet Data (HRPD) RAN connected to an EPS or LTE network and also a packet-switched portion of an HRPD core network in accordance with an embodiment of the invention.

FIG. 3 illustrates examples of user equipments (UEs) in accordance with embodiments of the invention.

FIG. 4 illustrates a communication device that includes logic configured to perform functionality in accordance with an embodiment of the invention.

FIG. 5 illustrates an exemplary server according to various aspects of the disclosure.

FIG. 6 illustrates an exemplary flow of an embodiment for a bearer assignment in a home network.

FIG. 7 illustrates an exemplary flow of an embodiment for core network management and assignment while roaming.

FIG. 8 illustrates an exemplary flow of an embodiment for assigning an alternate dedicated bearer while roaming.

FIG. 9 illustrates an exemplary flow of an embodiment for an application server-assisted bearer modification while roaming.

FIG. 10 illustrates an exemplary flow for managing a QoS provided for an application executing on a client device.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A client device, referred to herein as a user equipment (UE), may be mobile or stationary, and may communicate with a radio access network (RAN). As used herein, the term “UE” may be referred to interchangeably as an “access terminal” or “AT”, a “wireless device”, a “subscriber device”, a “subscriber terminal”, a “subscriber station”, a “user terminal” or UT, a “mobile terminal”, a “mobile station” and variations thereof. Generally, UEs can communicate with a core network via the RAN, and through the core network the UEs can be connected with external networks such as the Internet. Of course, other mechanisms of connecting to the core network and/or the Internet are also possible for the UEs, such as over wired access networks, WiFi networks (e.g., based on IEEE 802.11, etc.) and so on. UEs can be embodied by any of a number of types of devices including but not limited to PC cards, compact flash devices, external or internal modems, wireless or wireline phones, and so on. A communication link through which UEs can send signals to the RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

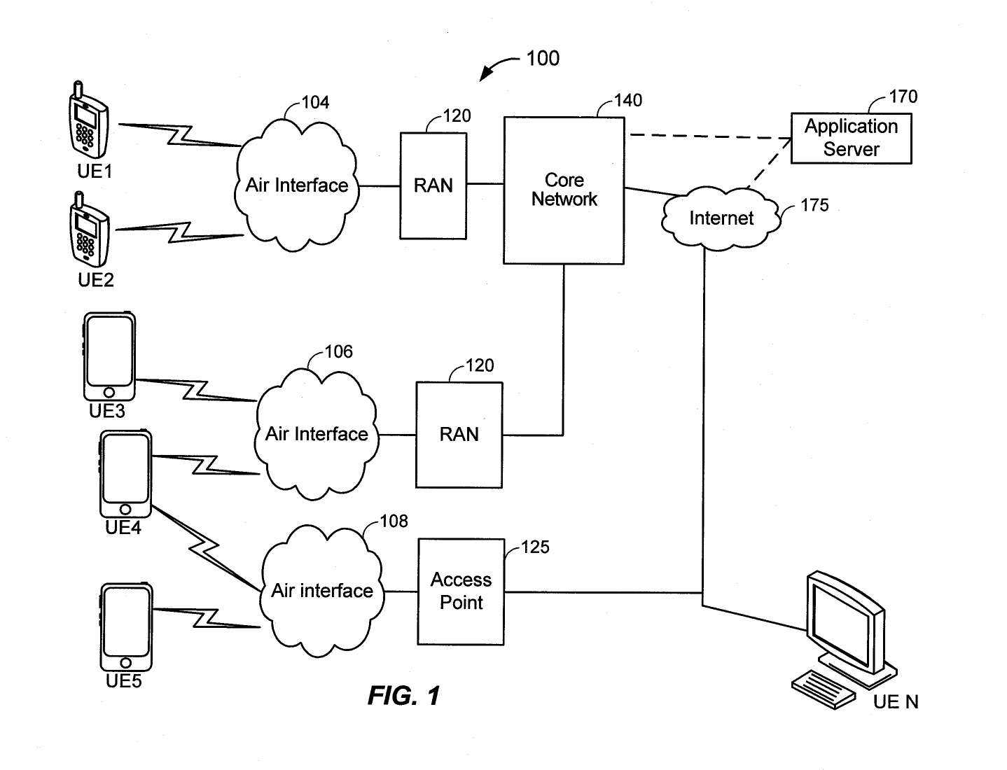

FIG. 1 illustrates a high-level system architecture of a wireless communications system 100 in accordance with an embodiment of the invention. The wireless communications system 100 contains UEs 1 . . . N. The UEs 1 . . . N can include cellular telephones, personal digital assistant (PDAs), pagers, a laptop computer, a desktop computer, and so on. For example, in FIG. 1, UEs 1 . . . 2 are illustrated as cellular calling phones, UEs 3 . . . 5 are illustrated as cellular touchscreen phones or smart phones, and UE N is illustrated as a desktop computer or PC.

Referring to FIG. 1, UEs 1 . . . N are configured to communicate with an access network (e.g., the RAN 120, an access point 125, etc.) over a physical communications interface or layer, shown in FIG. 1 as air interfaces 104, 106, 108 and/or a direct wired connection. The air interfaces 104 and 106 can comply with a given cellular communications protocol (e.g., CDMA, EVDO, eHRPD, GSM, EDGE, W-CDMA, LTE, etc.), while the air interface 108 can comply with a wireless IP protocol (e.g., IEEE 802.11). The RAN 120 includes a plurality of access points that serve UEs over air interfaces, such as the air interfaces 104 and 106. The access points in the RAN 120 can be referred to as access nodes or ANs, access points or APs, base stations or BSs, Node Bs, eNode Bs, and so on. These access points can be terrestrial access points (or ground stations), or satellite access points. The RAN 120 is configured to connect to a core network 140 that can perform a variety of functions, including bridging circuit switched (CS) calls between UEs served by the RAN 120 and other UEs served by the RAN 120 or a different RAN altogether, and can also mediate an exchange of packet-switched (PS) data with external networks such as Internet 175. The Internet 175 includes a number of routing agents and processing agents (not shown in FIG. 1 for the sake of convenience). In FIG. 1, UE N is shown as connecting to the Internet 175 directly (i.e., separate from the core network 140, such as over an Ethernet connection of WiFi or 802.11-based network). The Internet 175 can thereby function to bridge packet-switched data communications between UE N and UEs 1 . . . N via the core network 140. Also shown in FIG. 1 is the access point 125 that is separate from the RAN 120. The access point 125 may be connected to the Internet 175 independent of the core network 140 (e.g., via an optical communication system such as FiOS, a cable modem, etc.). The air interface 108 may serve UE 4 or UE 5 over a local wireless connection, such as IEEE 802.11 in an example. UE N is shown as a desktop computer with a wired connection to the Internet 175, such as a direct connection to a modem or router, which can correspond to the access point 125 itself in an example (e.g., for a WiFi router with both wired and wireless connectivity).

Referring to FIG. 1, an application server 170 is shown as connected to the Internet 175, the core network 140, or both. The application server 170 can be implemented as a plurality of structurally separate servers, or alternately may correspond to a single server. As will be described below in more detail, the application server 170 is configured to support one or more communication services (e.g., Voice-over-Internet Protocol (VoIP) sessions, Push-to-Talk (PTT) sessions, group communication sessions, social networking services, etc.) for UEs that can connect to the application server 170 via the core network 140 and/or the Internet 175.

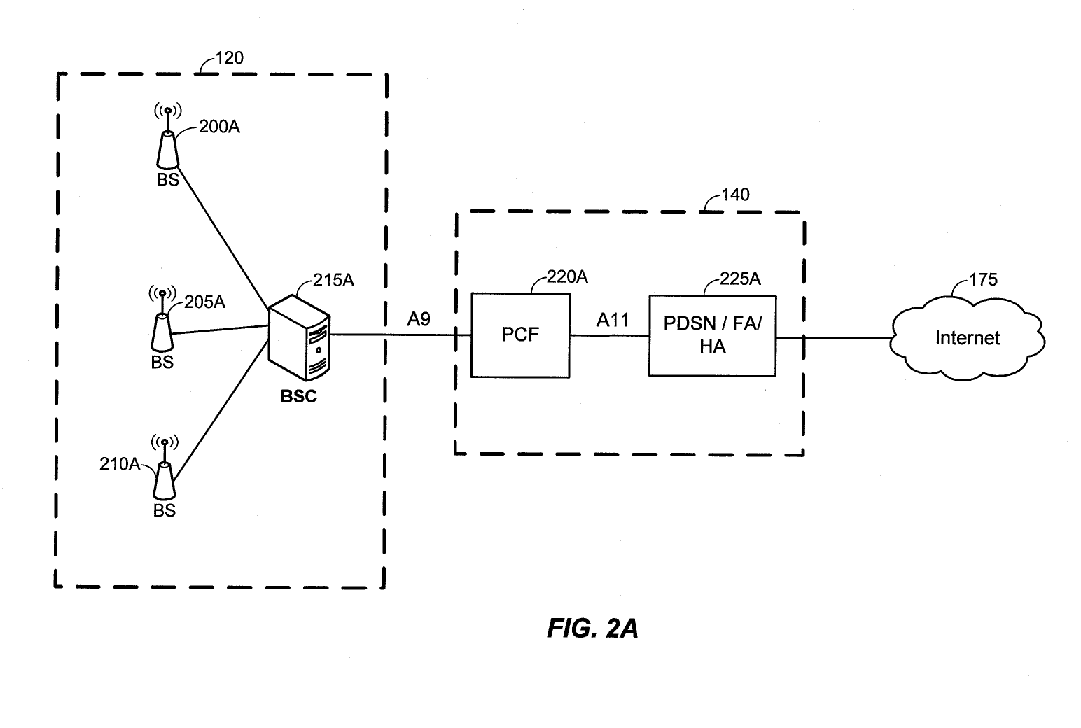

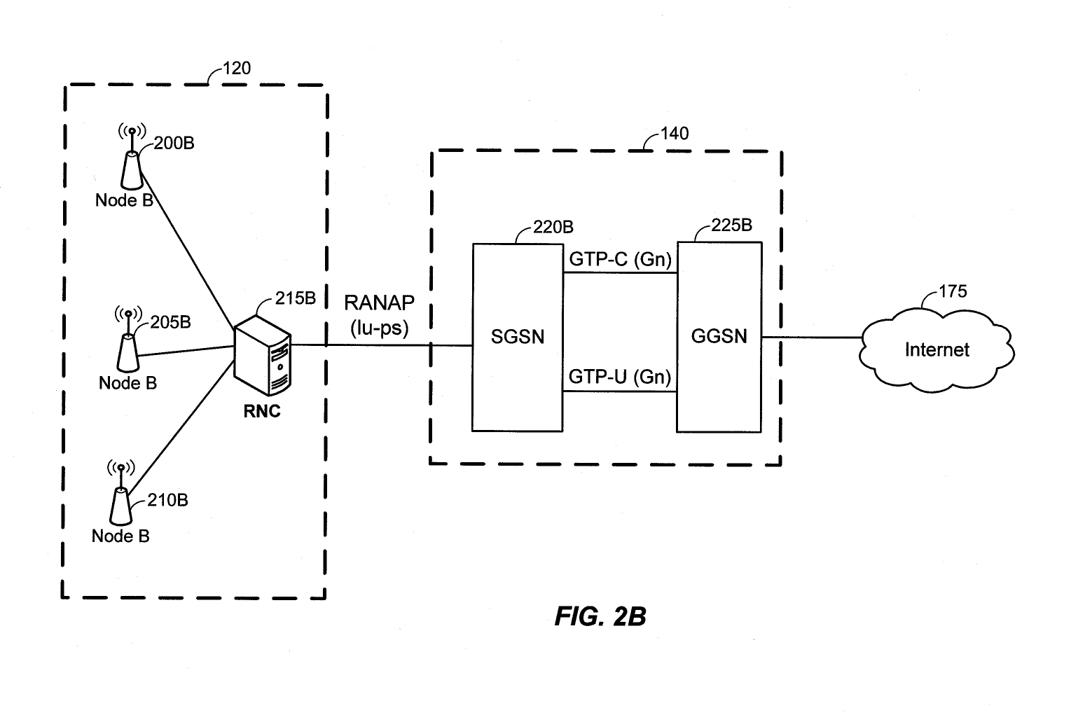

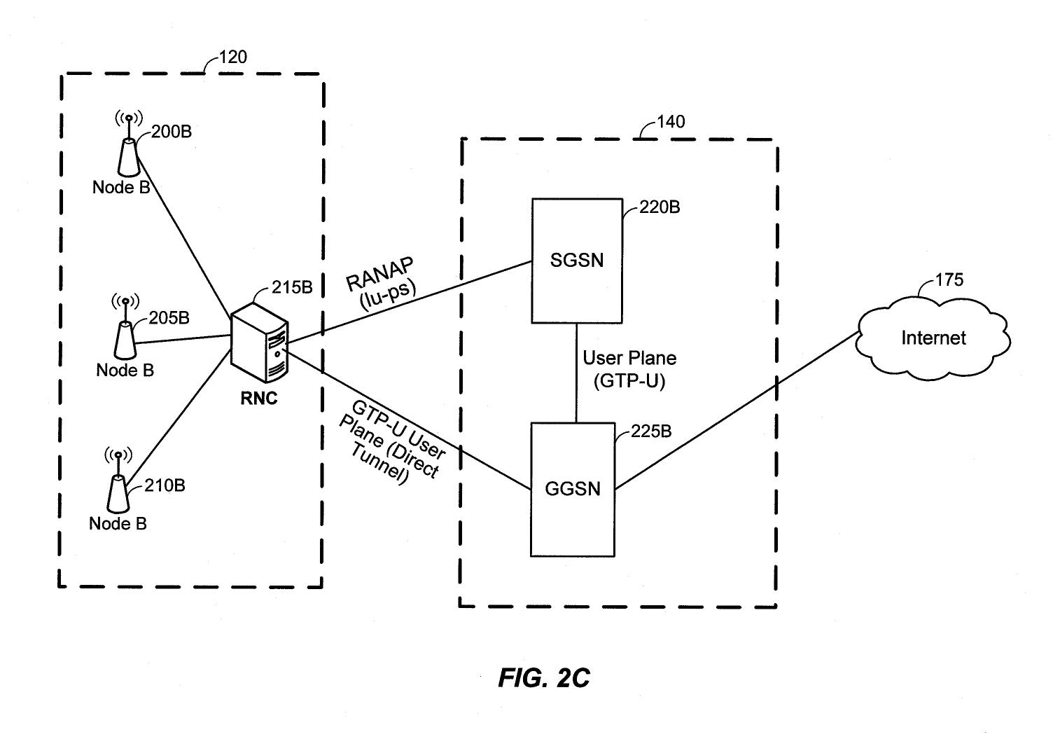

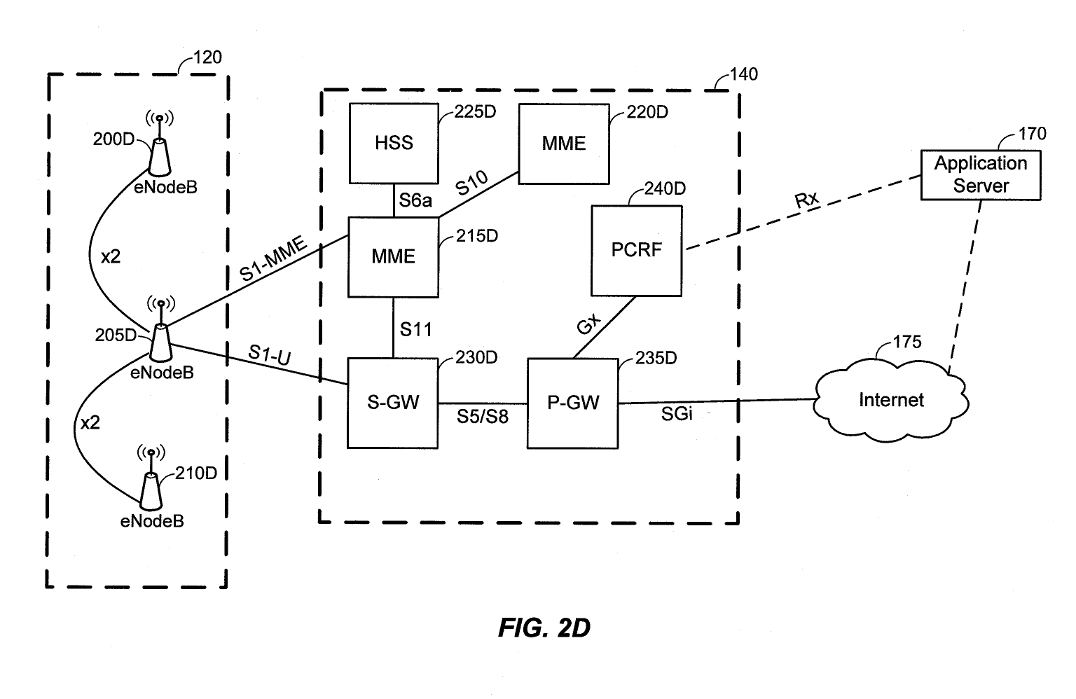

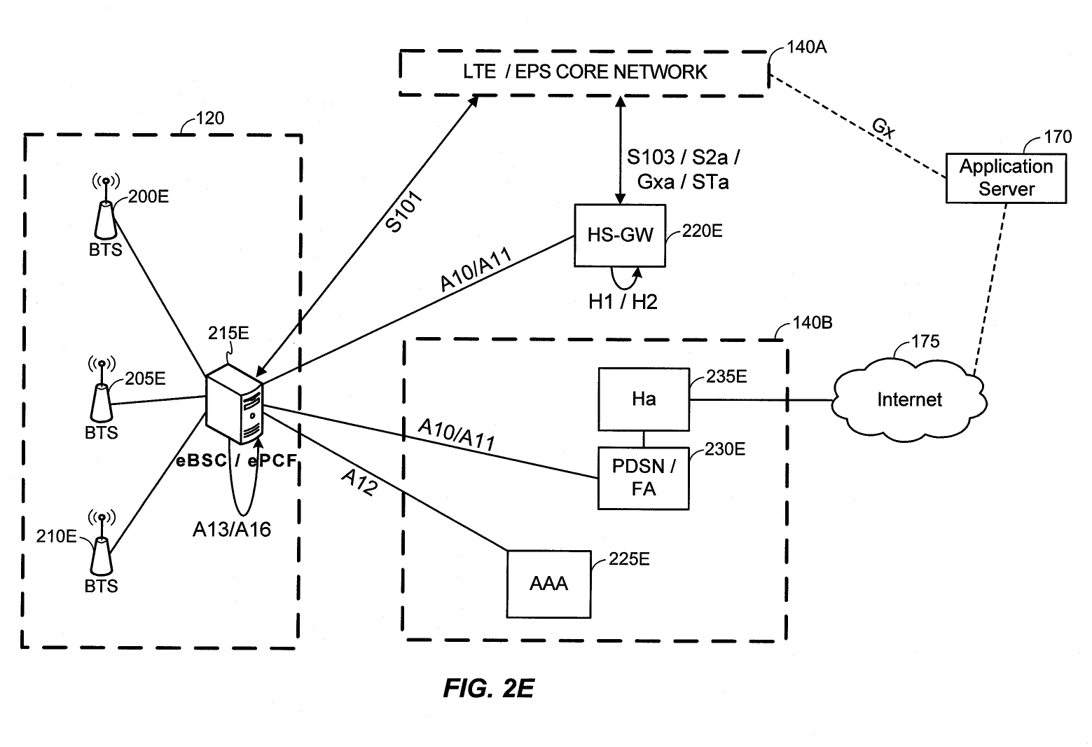

Examples of protocol-specific implementations for the RAN 120 and the core network 140 are provided below with respect to FIGS. 2A through 2D to help explain the wireless communications system 100 in more detail. In particular, the components of the RAN 120 and the core network 140 corresponds to components associated with supporting packet-switched (PS) communications, whereby legacy circuit-switched (CS) components may also be present in these networks, but any legacy CS-specific components are not shown explicitly in FIGS. 2A-2D.

FIG. 2A illustrates an example configuration of the RAN 120 and the core network 140 for packet-switched communications in a CDMA2000 1x Evolution-Data Optimized (EV-DO) network in accordance with an embodiment of the invention. Referring to FIG. 2A, the RAN 120 includes a plurality of base stations (BSs) 200A, 205A and 210A that are coupled to a base station controller (BSC) 215A over a wired backhaul interface. A group of BSs controlled by a single BSC is collectively referred to as a subnet. As will be appreciated by one of ordinary skill in the art, the RAN 120 can include multiple BSCs and subnets, and a single BSC is shown in FIG. 2A for the sake of convenience. The BSC 215A communicates with a packet control function (PCF) 220A within the core network 140 over an A9 connection. The PCF 220A performs certain processing functions for the BSC 215A related to packet data. The PCF 220A communicates with a Packet Data Serving Node (PDSN) 225A within the core network 140 over an A11 connection. The PDSN 225A has a variety of functions, including managing Point-to-Point (PPP) sessions, acting as a home agent (HA) and/or foreign agent (FA), and is similar in function to a Gateway General Packet Radio Service (GPRS) Support Node (GGSN) in GSM and UMTS networks (described below in more detail). The PDSN 225A connects the core network 140 to external IP networks, such as the Internet 175.

FIG. 2B illustrates an example configuration of the RAN 120 and a packet-switched portion of the core network 140 that is configured as a GPRS core network within a 3G UMTS W-CDMA system in accordance with an embodiment of the invention. Referring to FIG. 2B, the RAN 120 includes a plurality of Node Bs 200B, 205B and 210B that are coupled to a Radio Network Controller (RNC) 215B over a wired backhaul interface. Similar to 1x EV-DO networks, a group of Node Bs controlled by a single RNC is collectively referred to as a subnet. As will be appreciated by one of ordinary skill in the art, the RAN 120 can include multiple RNCs and subnets, and a single RNC is shown in FIG. 2B for the sake of convenience. The RNC 215B is responsible for signaling, establishing and tearing down bearer channels (i.e., data channels) between a Serving GRPS Support Node (SGSN) 220B in the core network 140 and UEs served by the RAN 120. If link layer encryption is enabled, the RNC 215B also encrypts the content before forwarding it to the RAN 120 for transmission over an air interface. The function of the RNC 215B is well-known in the art and will not be discussed further for the sake of brevity.

In FIG. 2B, the core network 140 includes the above-noted SGSN 220B (and potentially a number of other SGSNs as well) and a GGSN 225B. Generally, GPRS is a protocol used in GSM for routing IP packets. The GPRS core network (e.g., the GGSN 225B and one or more SGSNs 220B) is the centralized part of the GPRS system and also provides support for W-CDMA based 3G access networks. The GPRS core network is an integrated part of the GSM core network (i.e., the core network 140) that provides mobility management, session management and transport for IP packet services in GSM and W-CDMA networks.

The GPRS Tunneling Protocol (GTP) is the defining IP protocol of the GPRS core network. The GTP is the protocol which allows end users (e.g., UEs) of a GSM or W-CDMA network to move from place to place while continuing to connect to the Internet 175 as if from one location at the GGSN 225B. This is achieved by transferring the respective UE's data from the UE's current SGSN 220B to the GGSN 225B, which is handling the respective UE's session.

Three forms of GTP are used by the GPRS core network; namely, (i) GTP-U, (ii) GTP-C and (iii) GTP′ (GTP Prime). GTP-U is used for transfer of user data in separated tunnels for each packet data protocol (PDP) context. GTP-C is used for control signaling (e.g., setup and deletion of PDP contexts, verification of GSN reach-ability, updates or modifications such as when a subscriber moves from one SGSN to another, etc.). GTP′ is used for transfer of charging data from GSNs to a charging function.

Referring to FIG. 2B, the GGSN 225B acts as an interface between a GPRS backbone network (not shown) and the Internet 175. The GGSN 225B extracts packet data with associated a packet data protocol (PDP) format (e.g., IP or PPP) from GPRS packets coming from the SGSN 220B, and sends the packets out on a corresponding packet data network. In the other direction, the incoming data packets are directed by the GGSN connected UE to the SGSN 220B which manages and controls the Radio Access Bearer (RAB) of a target UE served by the RAN 120. Thereby, the GGSN 225B stores the current SGSN address of the target UE and its associated profile in a location register (e.g., within a PDP context). The GGSN 225B is responsible for IP address assignment and is the default router for a connected UE. The GGSN 225B also performs authentication and charging functions.

The SGSN 220B is representative of one of many SGSNs within the core network 140, in an example. Each SGSN is responsible for the delivery of data packets from and to the UEs within an associated geographical service area. The tasks of the SGSN 220B includes packet routing and transfer, mobility management (e.g., attach/detach and location management), logical link management, and authentication and charging functions. The location register of the SGSN 220B stores location information (e.g., current cell, current VLR) and user profiles (e.g., IMSI, PDP address(es) used in the packet data network) of all GPRS users registered with the SGSN 220B, for example, within one or more PDP contexts for each user or UE. Thus, SGSNs 220B are responsible for (i) de-tunneling downlink GTP packets from the GGSN 225B, (ii) uplink tunnel IP packets toward the GGSN 225B, (iii) carrying out mobility management as UEs move between SGSN service areas and (iv) billing mobile subscribers. As will be appreciated by one of ordinary skill in the art, aside from (i)-(iv), SGSNs configured for GSM/EDGE networks have slightly different functionality as compared to SGSNs configured for W-CDMA networks.

The RAN 120 (e.g., or UTRAN, in UMTS system architecture) communicates with the SGSN 220B via a Radio Access Network Application Part (RANAP) protocol. RANAP operates over a Iu interface (Iu-ps), with a transmission protocol such as Frame Relay or IP. The SGSN 220B communicates with the GGSN 225B via a Gn interface, which is an IP-based interface between SGSN 220B and other SGSNs (not shown) and internal GGSNs (not shown), and uses the GTP protocol defined above (e.g., GTP-U, GTP-C, GTP′, etc.). In the embodiment of FIG. 2B, the Gn between the SGSN 220B and the GGSN 225B carries both the GTP-C and the GTP-U. While not shown in FIG. 2B, the Gn interface is also used by the Domain Name System (DNS). The GGSN 225B is connected to a Public Data Network (PDN) (not shown), and in turn to the Internet 175, via a Gi interface with IP protocols either directly or through a Wireless Application Protocol (WAP) gateway.

FIG. 2C illustrates another example configuration of the RAN 120 and a packet-switched portion of the core network 140 that is configured as a GPRS core network within a 3G UMTS W-CDMA system in accordance with an embodiment of the invention. Similar to FIG. 2B, the core network 140 includes the SGSN 220B and the GGSN 225B. However, in FIG. 2C, Direct Tunnel is an optional function in Iu mode that allows the SGSN 220B to establish a direct user plane tunnel, GTP-U, between the RAN 120 and the GGSN 225B within a PS domain. A Direct Tunnel capable SGSN, such as SGSN 220B in FIG. 2C, can be configured on a per GGSN and per RNC basis whether or not the SGSN 220B can use a direct user plane connection. The SGSN 220B in FIG. 2C handles the control plane signaling and makes the decision of when to establish Direct Tunnel. When the RAB assigned for a PDP context is released (i.e. the PDP context is preserved) the GTP-U tunnel is established between the GGSN 225B and SGSN 220B in order to be able to handle the downlink packets.

FIG. 2D illustrates an example configuration of the RAN 120 and a packet-switched portion of the core network 140 based on an Evolved Packet System (EPS) or LTE network, in accordance with an embodiment of the invention. Referring to FIG. 2D, unlike the RAN 120 shown in FIGS. 2B-2C, the RAN 120 in the EPS/LTE network is configured with a plurality of Evolved Node Bs (ENodeBs or eNBs) 200D, 205D and 210D, without the RNC 215B from FIGS. 2B-2C. This is because ENodeBs in EPS/LTE networks do not require a separate controller (i.e., the RNC 215B) within the RAN 120 to communicate with the core network 140. In other words, some of the functionality of the RNC 215B from FIGS. 2B-2C is built into each respective eNodeB of the RAN 120 in FIG. 2D.

In FIG. 2D, the core network 140 includes a plurality of Mobility Management Entities (MMEs) 215D and 220D, a Home Subscriber Server (HSS) 225D, a Serving Gateway (S-GW) 230D, a Packet Data Network Gateway (P-GW) 235D and a Policy and Charging Rules Function (PCRF) 240D. Network interfaces between these components, the RAN 120 and the Internet 175 are illustrated in FIG. 2D and are defined in Table 1 (below) as follows:

TABLE 1
EPS/LTE Core Network Connection Definitions

| Network Interface | Description |
|---|---|
| S1-MME | Reference point for the control plane protocol between RAN 120 |
| | and MME 215D. |
| S1-U | Reference point between RAN 120 and S-GW 230D for the per |
| | bearer user plane tunneling and inter-eNodeB path switching |
| | during handover. |
| S5 | Provides user plane tunneling and tunnel management between S- |
| | GW 230D and P-GW 235D. It is used for S-GW relocation due to |
| | UE mobility and if the S-GW 230D needs to connect to a non- |
| | collocated P-GW for the required PDN connectivity. |
| S6a | Enables transfer of subscription and authentication data for |
| | authenticating/authorizing user access to the evolved system |
| | (Authentication, Authorization, and Accounting [AAA] interface) |
| | between MME 215D and HSS 225D. |
| Gx | Provides transfer of Quality of Service (QoS) policy and charging |
| | rules from PCRF 240D to Policy a Charging Enforcement |
| | Function (PCEF) component (not shown) in the P-GW 235D. |
| S8 | Inter-PLMN reference point providing user and control plane |
| | between the S-GW 230D in a Visited Public Land Mobile |
| | Network (VPLMN) and the P-GW 235D in a Home Public Land |
| | Mobile Network (HPLMN). S8 is the inter-PLMN variant of S5. |
| S10 | Reference point between MMEs 215D and 220D for MME |
| | relocation and MME to MME information transfer. |
| S11 | Reference point between MME 215D and S-GW 230D. |
| SGi | Reference point between the P-GW 235D and the packet data |
| | network, shown in FIG. 2D as the Internet 175. The Packet data |
| | network may be an operator external public or private packet data |
| | network or an intra-operator packet data network (e.g., for |
| | provision of IMS services). This reference point corresponds to Gi |
| | for 3GPP accesses. |
| X2 | Reference point between two different eNodeBs used for UE |
| | handoffs. |
| Rx | Reference point between the PCRF 240D and an application |
| | function (AF) that is used to exchanged application-level session |
| | information, where the AF is represented in FIG. 1 by the |
| | application server 170. |

A high-level description of the components shown in the RAN 120 and core network 140 of FIG. 2D will now be described. However, these components are each well-known in the art from various 3GPP TS standards, and the description contained herein is not intended to be an exhaustive description of all functionalities performed by these components.

Referring to FIG. 2D, the MMEs 215D and 220D are configured to manage the control plane signaling for the EPS bearers. MME functions include: Non-Access Stratum (NAS) signaling, NAS signaling security, Mobility management for inter- and intra-technology handovers, P-GW and S-GW selection, and MME selection for handovers with MME change.

Referring to FIG. 2D, the S-GW 230D is the gateway that terminates the interface toward the RAN 120. For each UE associated with the core network 140 for an EPS-based system, at a given point of time, there is a single S-GW. The functions of the S-GW 230D, for both the GTP-based and the Proxy Mobile IPv6 (PMIP)-based S5/S8, include: Mobility anchor point, Packet routing and forwarding, and setting the DiffSery Code Point (DSCP) based on a QoS Class Identifier (QCI) of the associated EPS bearer.

Referring to FIG. 2D, the P-GW 235D is the gateway that terminates the SGi interface toward the Packet Data Network (PDN), e.g., the Internet 175. If a UE is accessing multiple PDNs, there may be more than one P-GW for that UE; however, a mix of S5/S8 connectivity and Gn/Gp connectivity is not typically supported for that UE simultaneously. P-GW functions include for both the GTP-based S5/S8: Packet filtering (by deep packet inspection), UE IP address allocation, setting the DSCP based on the QCI of the associated EPS bearer, accounting for inter operator charging, uplink (UL) and downlink (DL) bearer binding as defined in 3GPP TS 23.203, UL bearer binding verification as defined in 3GPP TS 23.203. The P-GW 235D provides PDN connectivity to both GSM/EDGE Radio Access Network (GERAN)/UTRAN only UEs and E-UTRAN-capable UEs using any of E-UTRAN, GERAN, or UTRAN. The P-GW 235D provides PDN connectivity to E-UTRAN capable UEs using E-UTRAN only over the S5/S8 interface.

Referring to FIG. 2D, the PCRF 240D is the policy and charging control element of the EPS-based core network 140. In a non-roaming scenario, there is a single PCRF in the HPLMN associated with a UE's Internet Protocol Connectivity Access Network (IP-CAN) session. The PCRF terminates the Rx interface and the Gx interface. In a roaming scenario with local breakout of traffic, there may be two PCRFs associated with a UE's IP-CAN session: A Home PCRF (H-PCRF) is a PCRF that resides within a HPLMN, and a Visited PCRF (V-PCRF) is a PCRF that resides within a visited VPLMN. PCRF is described in more detail in 3GPP TS 23.203, and as such will not be described further for the sake of brevity. In FIG. 2D, the application server 170 (e.g., which can be referred to as the AF in 3GPP terminology) is shown as connected to the core network 140 via the Internet 175, or alternatively to the PCRF 240D directly via an Rx interface. Generally, the application server 170 (or AF) is an element offering applications that use IP bearer resources with the core network (e.g. UMTS PS domain/GPRS domain resources/LTE PS data services). One example of an application function is the Proxy-Call Session Control Function (P-CSCF) of the IP Multimedia Subsystem (IMS) Core Network sub system. The AF uses the Rx reference point to provide session information to the PCRF 240D. Any other application server offering IP data services over cellular network can also be connected to the PCRF 240D via the Rx reference point.

FIG. 2E illustrates an example of the RAN 120 configured as an enhanced High Rate Packet Data (HRPD) RAN connected to an EPS or LTE network 140A and also a packet-switched portion of an HRPD core network 140B in accordance with an embodiment of the invention. The core network 140A is an EPS or LTE core network, similar to the core network described above with respect to FIG. 2D.

In FIG. 2E, the eHRPD RAN includes a plurality of base transceiver stations (BTSs) 200E, 205E and 210E, which are connected to an enhanced BSC (eBSC) and enhanced PCF (ePCF) 215E. The eBSC/ePCF 215E can connect to one of the MMEs 215D or 220D within the EPS core network 140A over an S101 interface, and to an HRPD serving gateway (HSGW) 220E over A10 and/or A11 interfaces for interfacing with other entities in the EPS core network 140A (e.g., the S-GW 220D over an S103 interface, the P-GW 235D over an S2a interface, the PCRF 240D over a Gxa interface, a 3GPP AAA server (not shown explicitly in FIG. 2D) over an STa interface, etc.). The HSGW 220E is defined in 3GPP2 to provide the interworking between HRPD networks and EPS/LTE networks. As will be appreciated, the eHRPD RAN and the HSGW 220E are configured with interface functionality to EPC/LTE networks that is not available in legacy HRPD networks.

Turning back to the eHRPD RAN, in addition to interfacing with the EPS/LTE network 140A, the eHRPD RAN can also interface with legacy HRPD networks such as HRPD network 140B. As will be appreciated the HRPD network 140B is an example implementation of a legacy HRPD network, such as the EV-DO network from FIG. 2A. For example, the eBSC/ePCF 215E can interface with an authentication, authorization and accounting (AAA) server 225E via an A12 interface, or to a PDSN/FA 230E via an A10 or A11 interface. The PDSN/FA 230E in turn connects to HA 235A, through which the Internet 175 can be accessed. In FIG. 2E, certain interfaces (e.g., A13, A16, H1, H2, etc.) are not described explicitly but are shown for completeness and would be understood by one of ordinary skill in the art familiar with HRPD or eHRPD.

Referring to FIGS. 2B-2E, it will be appreciated that LTE core networks (e.g., FIG. 2D) and HRPD core networks that interface with eHRPD RANs and HSGWs (e.g., FIG. 2E) can support network-initiated Quality of Service (QoS) (e.g., by the P-GW, GGSN, SGSN, etc.) in certain cases.

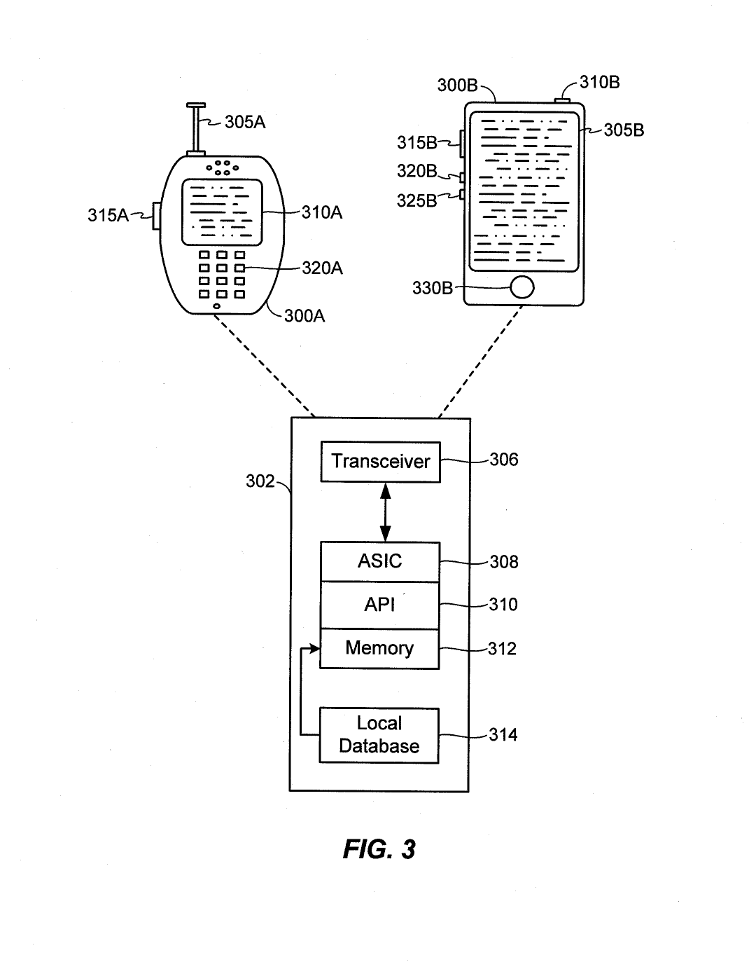

FIG. 3 illustrates examples of UEs in accordance with embodiments of the invention. Referring to FIG. 3, UE 300A is illustrated as a calling telephone and UE 300B is illustrated as a touchscreen device (e.g., a smart phone, a tablet computer, etc.). As shown in FIG. 3, an external casing of UE 300A is configured with an antenna 305A, display 310A, at least one button 315A (e.g., a PTT button, a power button, a volume control button, etc.) and a keypad 320A among other components, as is known in the art. Also, an external casing of UE 300B is configured with a touchscreen display 305B, peripheral buttons 310B, 315B, 320B and 325B (e.g., a power control button, a volume or vibrate control button, an airplane mode toggle button, etc.), at least one front-panel button 330B (e.g., a Home button, etc.), among other components, as is known in the art. While not shown explicitly as part of UE 300B, the UE 300B can include one or more external antennas and/or one or more integrated antennas that are built into the external casing of UE 300B, including but not limited to WiFi antennas, cellular antennas, satellite position system (SPS) antennas (e.g., global positioning system (GPS) antennas), and so on.

While internal components of UEs such as the UEs 300A and 300B can be embodied with different hardware configurations, a basic high-level UE configuration for internal hardware components is shown as platform 302 in FIG. 3. The platform 302 can receive and execute software applications, data and/or commands transmitted from the RAN 120 that may ultimately come from the core network 140, the Internet 175 and/or other remote servers and networks (e.g., application server 170, web URLs, etc.). The platform 302 can also independently execute locally stored applications without RAN interaction. The platform 302 can include a transceiver 306 operably coupled to an application specific integrated circuit (ASIC) 308, or other processor, microprocessor, logic circuit, or other data processing device. The ASIC 308 or other processor executes the application programming interface (API) 310 layer that interfaces with any resident programs in the memory 312 of the wireless device. The memory 312 can be comprised of read-only or random-access memory (RAM and ROM), EEPROM, flash cards, or any memory common to computer platforms. The platform 302 also can include a local database 314 that can store applications not actively used in memory 312, as well as other data. The local database 314 is typically a flash memory cell, but can be any secondary storage device as known in the art, such as magnetic media, EEPROM, optical media, tape, soft or hard disk, or the like.

Accordingly, an embodiment of the invention can include a UE (e.g., UE 300A, 300B, etc.) including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 308, memory 312, API 310 and local database 314 may all be used cooperatively to load, store and execute the various functions disclosed herein and thus the logic to perform these functions may be distributed over various elements. Alternatively, the functionality could be incorporated into one discrete component. Therefore, the features of the UEs 300A and 300B in FIG. 3 are to be considered merely illustrative and the invention is not limited to the illustrated features or arrangement.

The wireless communication between the UEs 300A and/or 300B and the RAN 120 can be based on different technologies, such as CDMA, W-CDMA, time division multiple access (TDMA), frequency division multiple access (FDMA), Orthogonal Frequency Division Multiplexing (OFDM), GSM, or other protocols that may be used in a wireless communications network or a data communications network. As discussed in the foregoing and known in the art, voice transmission and/or data can be transmitted to the UEs from the RAN using a variety of networks and configurations. Accordingly, the illustrations provided herein are not intended to limit the embodiments of the invention and are merely to aid in the description of aspects of embodiments of the invention.

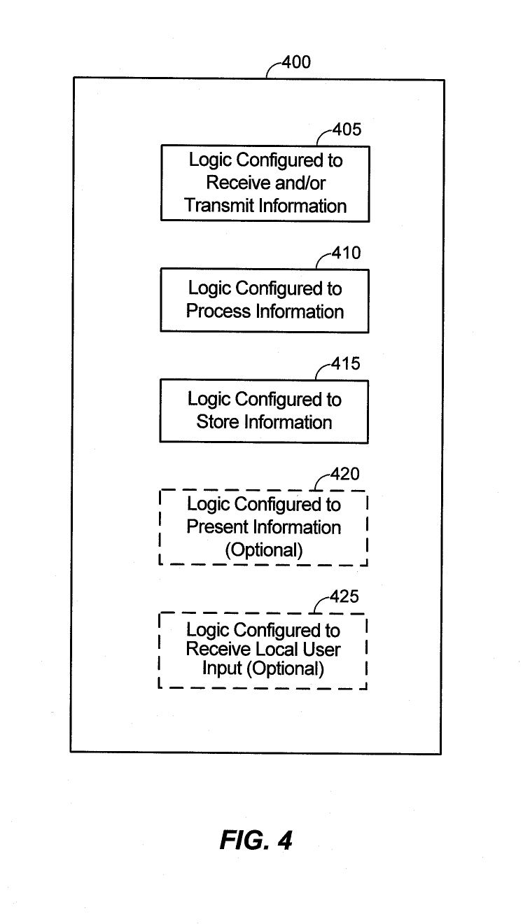

FIG. 4 illustrates a communication device 400 that includes logic configured to perform functionality. The communication device 400 can correspond to any of the above-noted communication devices, including but not limited to UEs 300A or 300B, any component of the RAN 120 (e.g., BSs 200A through 210A, BSC 215A, Node Bs 200B through 210B, RNC 215B, eNodeBs 200D through 210D, etc.), any component of the core network 140 (e.g., PCF 220A, PDSN 225A, SGSN 220B, GGSN 225B, MME 215D or 220D, HSS 225D, S-GW 230D, P-GW 235D, PCRF 240D), any components coupled with the core network 140 and/or the Internet 175 (e.g., the application server 170), and so on. Thus, communication device 400 can correspond to any electronic device that is configured to communicate with (or facilitate communication with) one or more other entities over the wireless communications system 100 of FIG. 1.

Referring to FIG. 4, the communication device 400 includes logic configured to receive and/or transmit information 405. In an example, if the communication device 400 corresponds to a wireless communications device (e.g., UE 300A or 300B, one of BSs 200A through 210A, one of Node Bs 200B through 210B, one of eNodeBs 200D through 210D, etc.), the logic configured to receive and/or transmit information 405 can include a wireless communications interface (e.g., Bluetooth, WiFi, 2G, CDMA, W-CDMA, 3G, 4G, LTE, etc.) such as a wireless transceiver and associated hardware (e.g., an RF antenna, a MODEM, a modulator and/or demodulator, etc.). In another example, the logic configured to receive and/or transmit information 405 can correspond to a wired communications interface (e.g., a serial connection, a USB or Firewire connection, an Ethernet connection through which the Internet 175 can be accessed, etc.). Thus, if the communication device 400 corresponds to some type of network-based server (e.g., PDSN, SGSN, GGSN, S-GW, P-GW, MME, HSS, PCRF, the application server 170, etc.), the logic configured to receive and/or transmit information 405 can correspond to an Ethernet card, in an example, that connects the network-based server to other communication entities via an Ethernet protocol. As an example, the logic configured to receive and/or transmit information 405 can include logic configured to receive, from a client device, an identifier of a first network servicing the client device. In a further example, the logic configured to receive and/or transmit information 405 can include sensory or measurement hardware by which the communication device 400 can monitor its local environment (e.g., an accelerometer, a temperature sensor, a light sensor, an antenna for monitoring local RF signals, etc.). The logic configured to receive and/or transmit information 405 can also include software that, when executed, permits the associated hardware of the logic configured to receive and/or transmit information 405 to perform its reception and/or transmission function(s). However, the logic configured to receive and/or transmit information 405 does not correspond to software alone, and the logic configured to receive and/or transmit information 405 relies at least in part upon hardware to achieve its functionality.

Referring to FIG. 4, the communication device 400 further includes logic configured to process information 410. In an example, the logic configured to process information 410 can include at least a processor. Example implementations of the type of processing that can be performed by the logic configured to process information 410 includes but is not limited to performing determinations, establishing connections, making selections between different information options, performing evaluations related to data, interacting with sensors coupled to the communication device 400 to perform measurement operations, converting information from one format to another (e.g., between different protocols such as .wmv to .avi, etc.), and so on. For example, the logic configured to process information 410 can include logic configured to receive, from the client device, an identifier of a first network servicing the client device, logic configured to determine a QoS of a supplemental link established by a second network for the application, logic configured to determine whether or not the QoS of the supplemental link meets requirements of the application, and/or logic configured to determine whether or not the first network is able to support an alternative acceptable QoS when the QoS of the supplemental link does not meet the requirements of the application. The processor included in the logic configured to process information 410 can correspond to a general purpose processor, a digital signal processor (DSP), an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The logic configured to process information 410 can also include software that, when executed, permits the associated hardware of the logic configured to process information 410 to perform its processing function(s). However, the logic configured to process information 410 does not correspond to software alone, and the logic configured to process information 410 relies at least in part upon hardware to achieve its functionality.

Referring to FIG. 4, the communication device 400 further includes logic configured to store information 415. In an example, the logic configured to store information 415 can include at least a non-transitory memory and associated hardware (e.g., a memory controller, etc.). For example, the non-transitory memory included in the logic configured to store information 415 can correspond to RAM memory, flash memory, ROM memory, EPROM memory, EEPROM memory, registers, hard disk, a removable disk, a CD-ROM, or any other form of storage medium known in the art. The logic configured to store information 415 can also include software that, when executed, permits the associated hardware of the logic configured to store information 415 to perform its storage function(s). However, the logic configured to store information 415 does not correspond to software alone, and the logic configured to store information 415 relies at least in part upon hardware to achieve its functionality.

Referring to FIG. 4, the communication device 400 further optionally includes logic configured to present information 420. In an example, the logic configured to present information 420 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 400. For example, if the communication device 400 corresponds to UE 300A or UE 300B as shown in FIG. 3, the logic configured to present information 420 can include the display 310A of UE 300A or the touchscreen display 305B of UE 300B. In a further example, the logic configured to present information 420 can be omitted for certain communication devices, such as network communication devices that do not have a local user (e.g., network switches or routers, remote servers, etc.). The logic configured to present information 420 can also include software that, when executed, permits the associated hardware of the logic configured to present information 420 to perform its presentation function(s). However, the logic configured to present information 420 does not correspond to software alone, and the logic configured to present information 420 relies at least in part upon hardware to achieve its functionality.

Referring to FIG. 4, the communication device 400 further optionally includes logic configured to receive local user input 425. In an example, the logic configured to receive local user input 425 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communication device 400. For example, if the communication device 400 corresponds to UE 300A or UE 300B as shown in FIG. 3, the logic configured to receive local user input 425 can include the keypad 320A, any of the buttons 315A or 310B through 325B, the touchscreen display 305B, etc. In a further example, the logic configured to receive local user input 425 can be omitted for certain communication devices, such as network communication devices that do not have a local user (e.g., network switches or routers, remote servers, etc.). The logic configured to receive local user input 425 can also include software that, when executed, permits the associated hardware of the logic configured to receive local user input 425 to perform its input reception function(s). However, the logic configured to receive local user input 425 does not correspond to software alone, and the logic configured to receive local user input 425 relies at least in part upon hardware to achieve its functionality.

Referring to FIG. 4, while the configured logics of 405 through 425 are shown as separate or distinct blocks in FIG. 4, it will be appreciated that the hardware and/or software by which the respective configured logic performs its functionality can overlap in part. For example, any software used to facilitate the functionality of the configured logics of 405 through 425 can be stored in the non-transitory memory associated with the logic configured to store information 415, such that the configured logics of 405 through 425 each performs their functionality (i.e., in this case, software execution) based in part upon the operation of software stored by the logic configured to store information 415. Likewise, hardware that is directly associated with one of the configured logics can be borrowed or used by other configured logics from time to time. For example, the processor of the logic configured to process information 410 can format data into an appropriate format before being transmitted by the logic configured to receive and/or transmit information 405, such that the logic configured to receive and/or transmit information 405 performs its functionality (i.e., in this case, transmission of data) based in part upon the operation of hardware (i.e., the processor) associated with the logic configured to process information 410.

Generally, unless stated otherwise explicitly, the phrase “logic configured to” as used throughout this disclosure is intended to invoke an embodiment that is at least partially implemented with hardware, and is not intended to map to software-only implementations that are independent of hardware. Also, it will be appreciated that the configured logic or “logic configured to” in the various blocks are not limited to specific logic gates or elements, but generally refer to the ability to perform the functionality described herein (either via hardware or a combination of hardware and software). Thus, the configured logics or “logic configured to” as illustrated in the various blocks are not necessarily implemented as logic gates or logic elements despite sharing the word “logic.” Other interactions or cooperation between the logic in the various blocks will become clear to one of ordinary skill in the art from a review of the embodiments described below in more detail.

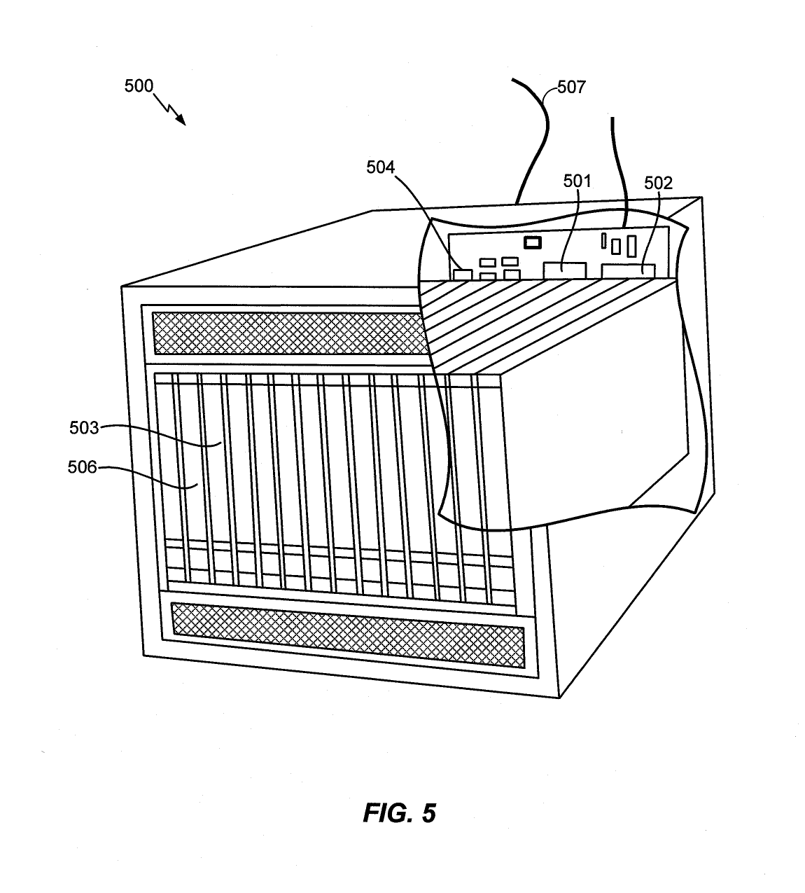

The various embodiments may be implemented on any of a variety of commercially available server devices, such as server 500 illustrated in FIG. 5. In an example, the server 500 may correspond to one example configuration of the application server 170 described above. In FIG. 5, the server 500 includes a processor 501 coupled to volatile memory 502 and a large capacity nonvolatile memory, such as a disk drive 503. The server 500 may also include a floppy disc drive, compact disc (CD) or DVD disc drive 506 coupled to the processor 501. The server 500 may also include network access ports 504 coupled to the processor 501 for establishing data connections with a network 507, such as a local area network coupled to other broadcast system computers and servers or to the Internet. In context with FIG. 4, it will be appreciated that the server 500 of FIG. 5 illustrates one example implementation of the communication device 400, whereby the logic configured to transmit and/or receive information 405 corresponds to the network access points 504 used by the server 500 to communicate with the network 507, the logic configured to process information 410 corresponds to the processor 501, and the logic configuration to store information 415 corresponds to any combination of the volatile memory 502, the disk drive 503 and/or the disc drive 506. The optional logic configured to present information 420 and the optional logic configured to receive local user input 425 are not shown explicitly in FIG. 5 and may or may not be included therein. Thus, FIG. 5 helps to demonstrate that the communication device 400 may be implemented as a server, in addition to a UE implementation as in 305A or 305B as in FIG. 3.

Home-terminated, network-initiated QoS can result in suboptimal behavior. 3GPP networks support home-terminated bearers for users roaming onto visited networks. A high priority GBR application, denoted as “App*,” is any application that requires GBR QoS on an associated EPS media bearer for supporting its communication sessions (e.g., PTT sessions, VoIP sessions, etc.) and that uses a dedicated APN, where the dedicated APN is configured to specifically identify the App* to external devices, such as components of the LTE core network 140. An App* requires a higher QoS, which is provided in the home network of operation. However, the visited network may not provide the requisite QoS for the App*.

Specifically, when a network-initiated QoS is provided to a UE on a separate dedicated bearer for an APN, the core network 140 may allocate resources that the RAN, such as RAN 120, in the visited network may not support. The visited RAN 120 may therefore downgrade the QoS on the dedicated bearer. In that case, the UE has a dedicated bearer without the requisite QoS, which is a waste of resources on the network and the UE, as the UE could otherwise leverage the existing default bearer when the QoS is not available on the dedicated bearer.

Accordingly, the various embodiments provide a method for QoS management in roaming scenarios based on location and application server assistance. Specifically, given a predetermined/visited RAN 120 and its corresponding capability, the core network 140 identifies the RAN 120 based on network identifiers. The core network 140 enables network-initiated QoS and a dedicated bearer when the identified/visited RAN 120 supports the requisite QoS. However, when the identified/visited RAN 120 does not support the requisite QoS, the core network 140 suppresses network-initiated QoS and leverages the default bearer instead.

Alternatively, when the core network 140 cannot identify the visited RAN 120, the application server, such as application server 170, can trigger the core network 140 to release any resource when the RAN 120 does not support the requisite QoS.

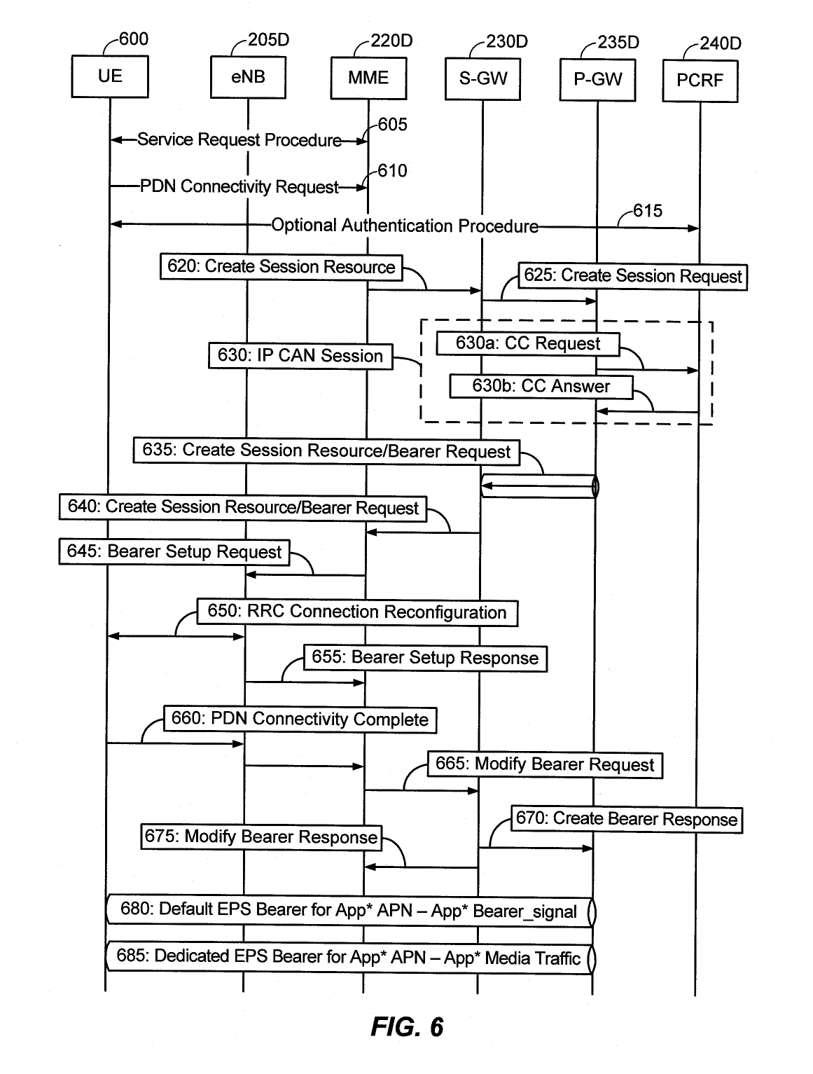

FIG. 6 illustrates an exemplary flow of an embodiment for a bearer assignment in a home network. At 605, the UE 600 and the MME, such as MME 220D, conduct a service request procedure. At 610, the UE 600 initiates a PDN connectivity request with the MME 220D while seeking an IPv4 assignment and DNS IP address assignments in the protocol configuration options (PCO) information element. At 615, the UE 600 and the PCRF, such as PCRF 240D, optionally conduct an authentication procedure to authenticate the UE 600.

At 620, the MME 220D transmits a message to the S-GW, such as S-GW 230D, instructing it to create a session resource. At 625, the S-GW 230D sends a session creation request to the P-GW, such as P-GW 235D.

At 630a, the P-GW 235D sends an IP CAN credit control (CC) request to the PCRF 240D. At 630b, the PCRF 240D sends a CC answer to the P-GW 235D. This is the IP CAN session 630. During the IP CAN session 630, the PCRF 240D detects the App* APN and applies, or subscribes, the App* QCI_{signaling} to the default bearer and initiates a dedicated bearer with the App* QCI_{media}.

At 635, the P-GW 235D sends a message to the S-GW 230D instructing it to create a session resource and to create a bearer request. The message includes the IPv4 address and DNS IP address provided by the P-GW 235D in the PCO. At 640, the S-GW 230D sends a message to the MME 220D instructing it to create the session resource and to create the bearer request. The S5 GTP tunnels are created with this information.

At 645, the MME 220D sends the bearer setup request to the eNB, such as eNB 205D. This is also the PDN connectivity acceptance and dedicated bearer setup request. At 650, the UE 600 and the eNB 205D conduct a radio resource control (RRC) connectivity reconfiguration. At this point, the UE 600 also receives the IPv4 address and DNS IP address provided by the P-GW 236D in the PCO. At 655, the eNB 205D sends a bearer setup response to the MME 220D. The response includes the tunnel end point identifier (TEID) of the eNB 205D and indicates that the S1 GTP tunnels have been created.

At 660, the UE 600 conducts a direct transfer to the eNB 205D, and indicates that the PDN connectivity is complete. The eNB 205D forwards this information to the MME 220D. At 665, the MME 220D sends a message to the S-GW 230D instructing it to modify the bearer request. At 670, the S-GW 230D sends a message to the P-GW 235D instructing it to create a bearer response. At 675, the S-GW 230D sends a response to the MME 220D modifying the bearer response.

At 680, the default EPS bearer for the App* APN, including the App* bearer signal, is established. At 685, the dedicated EPS bearer for the App* APN, including the App* media traffic, is established.

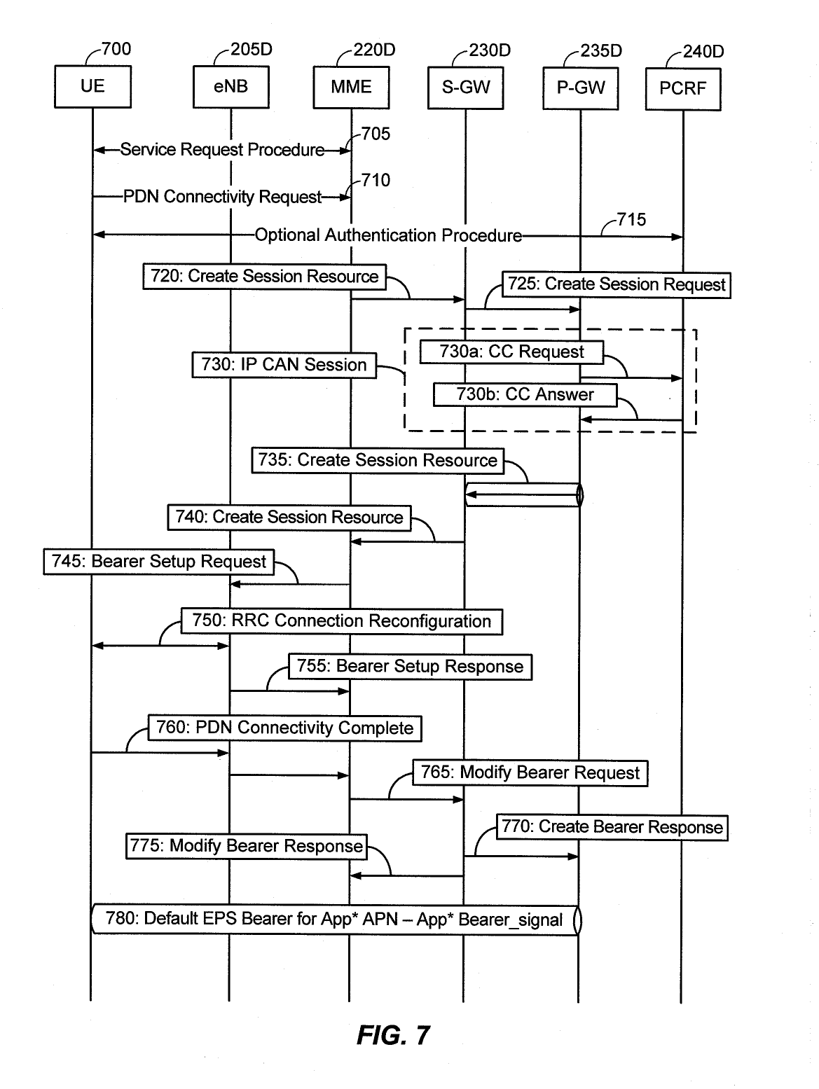

FIG. 7 illustrates an exemplary flow of an embodiment for core network management and assignment while roaming. At 705, a UE 700 and the MME, such as MME 220D, conduct a service request procedure. At 710, the UE 700 initiates a PDN connectivity request with the MME 220D while seeking an IPv4 assignment and DNS IP address assignments in the PCO. At 715, the UE 700 and the PCRF, such as PCRF 240D, optionally conduct an authentication procedure.

At 720, the MME 220D transmits a message to the S-GW, such as S-GW 230D, instructing it to create a session resource. At 725, the S-GW 230D sends a session creation request to the P-GW, such as P-GW 235D.

At 730a, the P-GW 235D sends a CC request to the PCRF 240D. At 730b, the PCRF 240D sends a CC answer to the P-GW 235D. This is the IP CAN session 730. During the IP CAN session 730, the PCRF 240D detects the App* APN and applies, or subscribes, the App* QCI_{signaling} to the default bearer. The PCRF 240D identifies that the visited evolved universal terrestrial radio access network (EUTRAN) does not support the App* QoS and therefore does not initiate a dedicated bearer with the App* QCI_{media}. Alternatively, the function of identifying the App* APN and detecting the visited network to apply the bearer management policy can be embedded in the P-GW.

At 735, the P-GW 235D sends a message to the S-GW 230D instructing it to create a session resource. The message includes the IPv4 address and DNS IP address provided by the P-GW 235D in the PCO. At 740, the S-GW 230D sends a message to the MME 220D instructing it to create the session resource. The S5 GTP tunnels are created with this information.

At 745, the MME 220D sends the bearer setup request to the eNB, such as eNB 205D. This is also the PDN connectivity acceptance. At 750, the UE 700 and the eNB 205D conduct an RRC connectivity reconfiguration. The UE 700 determines that a dedicated bearer was not assigned and accordingly uses the default bearer for all services. At 755, the eNB 205D sends a bearer setup response to the MME 220D. The response includes the TEID of the eNB 205D and indicates that the S1 GTP tunnels have been created.

At 760, the UE 700 conducts a direct transfer to the eNB 205D, and indicates that the PDN connectivity is complete. The eNB 205D forwards this information to the MME 220D. At 765, the MME 220D sends a message to the S-GW 230D instructing it to modify the bearer request. At 770, the S-GW 230D sends a message to the P-GW 235D instructing it to create a bearer response. At 775, the S-GW 230D sends a response to the MME 220D modifying the bearer response. At 780, the default EPS bearer for the App* APN, including the App* bearer signal, is established.

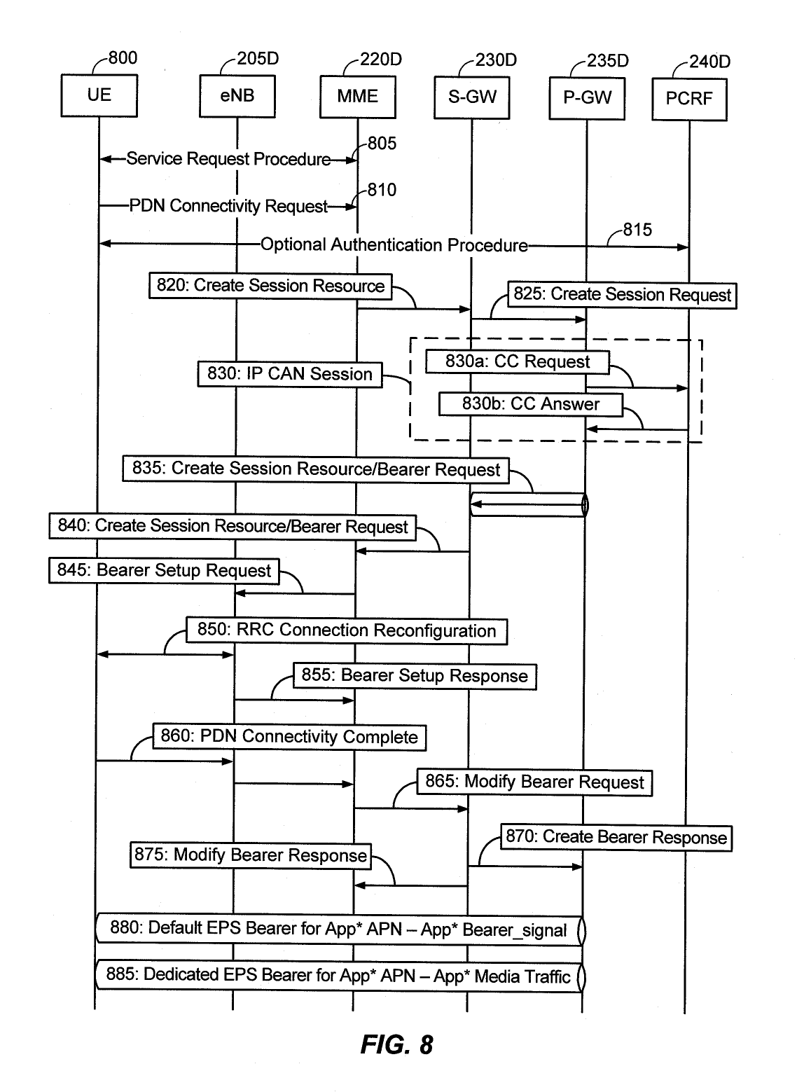

FIG. 8 illustrates an exemplary flow of an embodiment for assigning an alternate dedicated bearer while roaming. At 805, a UE 800 and the MME, such as MME 220D, conduct a service request procedure. At 810, the UE 800 initiates a PDN connectivity request with the MME 220D while seeking an IPv4 assignment and DNS IP address assignments in the PCO. At 815, the UE 800 and the PCRF, such as PCRF 240D, optionally conduct an authentication procedure.

At 820, the MME 220D transmits a message to the S-GW, such as S-GW 230D, instructing it to create a session resource. At 825, the S-GW 230D sends a session creation request to the P-GW, such as P-GW 235D.

At 830a, the P-GW 235D sends a CC request to the PCRF 240D. At 830b, the PCRF 240D sends a CC answer to the P-GW 235D. This is the IP CAN session 830. During the IP CAN session 830, the PCRF 240D detects the App* APN and applies, or subscribes, the App* QCI_{signaling} to the default bearer. The PCRF 240D also identifies the lack of App* QoS support and initiates a dedicated bearer with an alternative QoS, as available in the visited RAN 120.

At 835, the P-GW 235D sends a message to the S-GW 230D instructing it to create a session resource and to create a bearer request. The message includes the IPv4 address and DNS IP address provided by the P-GW 235D in the PCO. At 840, the S-GW 230D sends a message to the MME 220D instructing it to create the session resource and to create the bearer request. The S5 GTP tunnels are created with this information.

At 845, the MME 220D sends the bearer setup request to the eNB, such as eNB 205D. This is also the PDN connectivity acceptance and dedicated bearer setup request. At 850, the UE 800 and the eNB 205D conduct an RRC connectivity reconfiguration. At this point, the UE 800 also receives the IPv4 address and DNS IP address provided by the P-GW 235D in the PCO. At 855, the eNB 205D sends a bearer setup response to the MME 220D. The response includes the TEID of the eNB 205D and indicates that the S1 GTP tunnels have been created.

At 860, the UE 800 conducts a direct transfer to the eNB 205D, and indicates that the PDN connectivity is complete. At this point, the UE 800 identifies the alternative QoS assigned in this procedure. The eNB 205D forwards the PDN connectivity message to the MME 220D. At 865, the MME 220D sends a message to the S-GW 230D instructing it to modify the bearer request. At 870, the S-GW 230D sends a message to the P-GW 235D instructing it to create a bearer response. At 875, the S-GW 230D sends a response to the MME 220D modifying the bearer response.

At 880, the default EPS bearer for the App* APN, including the App* bearer signal, is established. At 885, the dedicated EPS bearer for the App* APN, including the App* media traffic, is established.

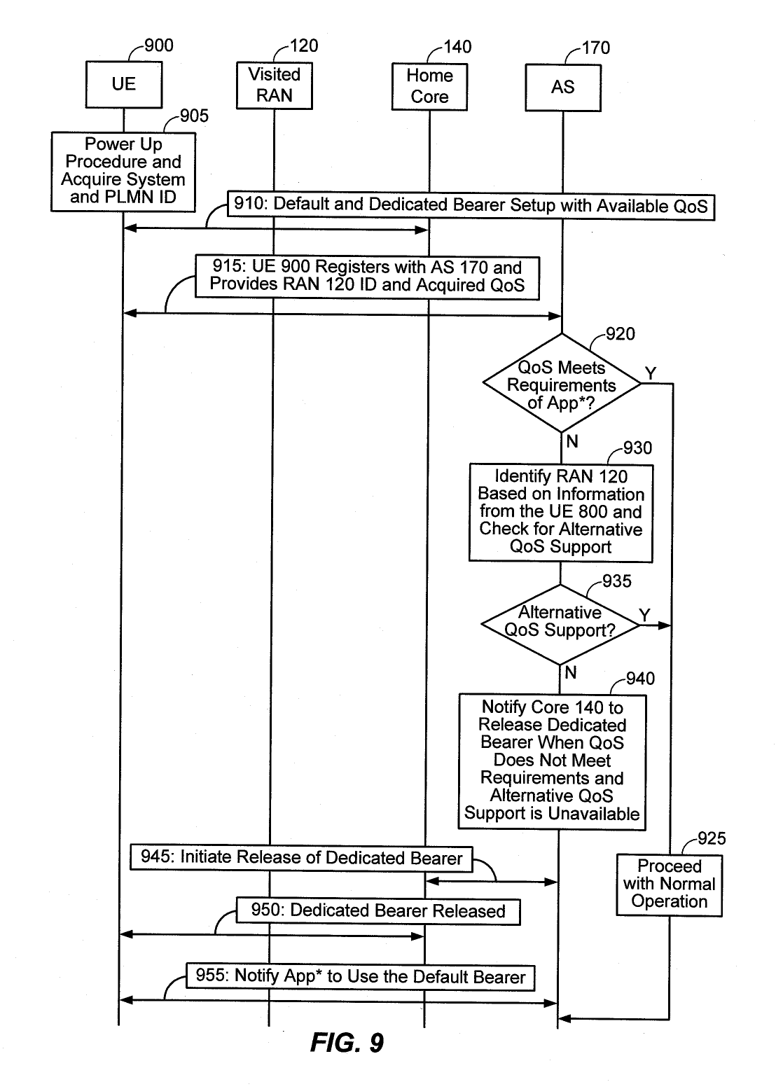

FIG. 9 illustrates an exemplary flow of an embodiment for an application server-assisted bearer modification while roaming. At 905, UE 900 performs a power up procedure and acquires the system and PLMN identification. At 910, the UE 900 communicates with its home core network, such as core network 140, to setup the default and dedicated bearers with the available QoS. At 915, the UE 900 registers with the application server, such as application server 170, and provides it with the identifier of the visited RAN, such as RAN 120, and the acquired QoS.

At 920, the application server 170 determines whether the acquired QoS meets the requirements of the App*. The application server 170 may determine whether the QoS meets the requirements of the App* by comparing the elements of the available QoS to a list of requirements of the App*. If the QoS meets the requirements of the App*, then at 925, the application server 170 proceeds with normal operation. If it does not, then at 930, the application server 170 identifies the visited RAN 120 based on the information from the UE 900 and checks for alternative QoS support. At 935, if there is alternative QoS support, the application server 170 initiates the establishment of the alternative QoS and any necessary bearer establishment, if needed. Normal operation ensues at 925 following the alternative QoS arrangements. If, however, at 935, alternative QoS support is unavailable, then at 940, the application server 170 notifies the home core network 140 to release the dedicated bearer.

At 945, the application server 170 and the home core network 140 communicate to initiate the release of the dedicated bearer. At 950, the home core network 140 and the UE 900 communicate to release the dedicated bearer. At 955, the application server 170 and the UE 900 communicate to notify the App* to use the default bearer for its media traffic.

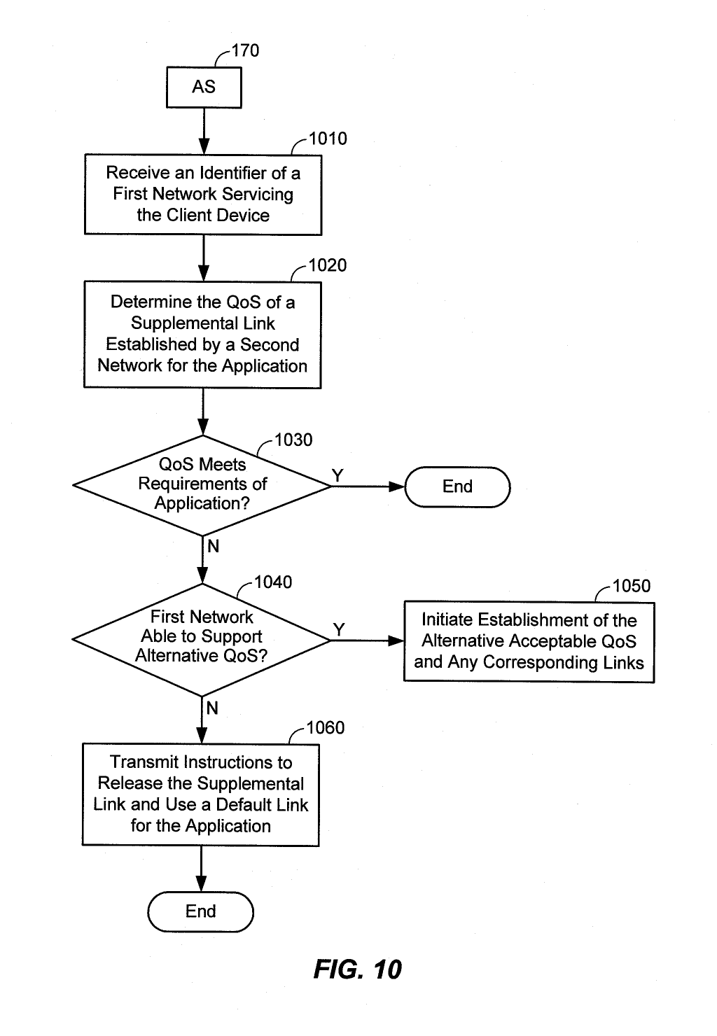

FIG. 10 illustrates an exemplary flow for managing a QoS provided for an application executing on a client device. The flow of FIG. 10 may be performed by the application server 170. The client device may be any of UEs 300A, 300B, 400, 600, 700, 800, or 900. The application may be a GBR application, such as an App*.

At 1010, the application server 170 receives, from the client device, an identifier of a first network servicing the client device. The first network may be a RAN, such as RAN 120. The first network may also be a roaming network from the viewpoint of the client device.

At 1020, the application server 170 determines the QoS of a supplemental link established by a second network for the application. The second network may be a core network, such as core network 140. The supplemental link may be a dedicated bearer in LTE, a secondary PDP in UMTS, or an auxiliary PPP in CDMA2000. The application server 170 may determine the QoS of the supplemental link from one or more parameters representing the QoS of the supplemental link received from the client device.

At 1030, the application server 170 determines whether or not the QoS of the supplemental link meets the requirements of the application. The QoS of the supplemental link may not meet the requirements of the application if the first network does not support all resources allocated to the supplemental link and/or downgrades the QoS of the supplemental link. If the QoS of the supplemental link does meet the requirements of the application, the flow ends at the application server 170 and the client device uses the supplemental link for the application.

At 1040, if the QoS of the supplemental link does not meet the requirements of the application, the application server 170 determines whether or not the first network is able to support an alternative acceptable QoS. An acceptable alternative QoS is one that meets the requirements of the application. The application server 170 may determine whether or not the first network is able to support the alternative acceptable QoS based on the identifier of the first network received from the client device.

At 1050, if the first network is able to support the alternative acceptable QoS, the application server 170 initiates establishment of the alternative acceptable QoS and one or more corresponding links. At 1060, if the first network is not able to support the alternative acceptable QoS, the application server 170 transmits one or more instructions to release the supplemental link and to use a default link for the application. The one or more instructions to release the supplemental link are transmitted to the second network, and the one or more instructions to use the default link are transmitted to the client device. The default link may be a default bearer in LTE, a primary PDP in UMTS, or a main service PPP in CDMA 2000.

While the embodiments above have been described primarily with reference to LTE-based networks, it will be appreciated that other embodiments can be directed to 1x EV-DO architecture in CDMA2000 networks, GPRS architecture in W-CDMA or UMTS networks and/or other types of network architectures and/or protocols.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method for managing, at an application server, a quality of service (QoS) provided for an application executing on a client device, comprising:
receiving, from the client device, an identifier of a first network servicing the client device;
determining a QoS of a supplemental link established by a second network for the application;
determining whether or not the QoS of the supplemental link meets requirements of the application; and
determining whether or not the first network is able to support an alternative acceptable QoS when the QoS of the supplemental link does not meet the requirements of the application.

2. The method of claim 1, further comprising:
initiating establishment of the alternative acceptable QoS and one or more corresponding links when the first network is able to support the alternative acceptable QoS.

3. The method of claim 1, further comprising:
transmitting one or more instructions to release the supplemental link and to use a default link for the application when the first network is not able to support the alternative acceptable QoS.

4. The method of claim 3, wherein the one or more instructions to release the supplemental link are transmitted to the second network.

5. The method of claim 3, wherein the one or more instructions to use the default link are transmitted to the client device.

6. The method of claim 1, wherein the default link comprises a dedicated bearer in Long Term Evolution (LTE), a secondary Packet Data Protocol (PDP) in Universal Mobile Telecommunications System (UMTS), or an auxiliary Point-to-Point (PPP) in Code Division Multiple Access (CDMA) 2000.

7. The method of claim 1, wherein the supplemental link comprises a default bearer in LTE, a primary PDP in UMTS, or a main service PPP in CDMA 2000.

8. The method of claim 1, wherein the client device uses the supplemental link for the application when the QoS of the supplemental link meets the requirements of the application.

9. The method of claim 1, wherein the determining the QoS of the supplemental link comprises:
receiving one or more parameters representing the QoS of the supplemental link from the client device.

10. The method of claim 1, wherein the determining whether or not the first network is able to support an alternative acceptable QoS is based on the identifier of the first network.

11. The method of claim 1, wherein the QoS of the supplemental link does not meet the requirements of the application when the first network does not support all resources allocated to the supplemental link and/or downgrades the QoS of the supplemental link.

12. The method of claim 1, wherein an acceptable alternative QoS meets the requirements of the application.

13. The method of claim 1, wherein the application comprises a guaranteed bit rate (GBR) application.

14. The method of claim 1, wherein the first network comprises a radio access network (RAN).

15. The method of claim 1, wherein the first network comprises a roaming network from the viewpoint of the client device.

16. The method of claim 1, wherein the second network comprises a core network.

17. An apparatus for managing, at an application server, a quality of service (QoS) provided for an application executing on a client device, comprising:
logic configured to receive, from the client device, an identifier of a first network servicing the client device;
logic configured to determine a QoS of a supplemental link established by a second network for the application;
logic configured to determine whether or not the QoS of the supplemental link meets requirements of the application; and
logic configured to determine whether or not the first network is able to support an alternative acceptable QoS when the QoS of the supplemental link does not meet the requirements of the application.

18. The apparatus of claim 17, further comprising:
logic configured to initiate establishment of the alternative acceptable QoS and one or more corresponding links when the first network is able to support the alternative acceptable QoS.

19. The apparatus of claim 17, further comprising:
logic configured to transmit one or more instructions to release the supplemental link and to use a default link for the application when the first network is not able to support the alternative acceptable QoS.

20. The apparatus of claim 19, wherein the one or more instructions to release the supplemental link are transmitted to the second network.

21. The apparatus of claim 19, wherein the one or more instructions to use the default link are transmitted to the client device.

22. The apparatus of claim 17, wherein the default link comprises a dedicated bearer in Long Term Evolution (LTE), a secondary Packet Data Protocol (PDP) in Universal Mobile Telecommunications System (UMTS), or an auxiliary Point-to-Point (PPP) in Code Division Multiple Access (CDMA) 2000.

23. The apparatus of claim 17, wherein the supplemental link comprises a default bearer in LTE, a primary PDP in UMTS, or a main service PPP in CDMA 2000.

24. The apparatus of claim 17, wherein the client device uses the supplemental link for the application when the QoS of the supplemental link meets the requirements of the application.

25. The apparatus of claim 17, wherein the logic configured to determine the QoS of the supplemental link comprises:
logic configured to receive one or more parameters representing the QoS of the supplemental link from the client device.

26. The apparatus of claim 17, wherein determining whether or not the first network is able to support an alternative acceptable QoS is based on the identifier of the first network.

27. The apparatus of claim 17, wherein the QoS of the supplemental link does not meet the requirements of the application when the first network does not support all resources allocated to the supplemental link and/or downgrades the QoS of the supplemental link.

28. The apparatus of claim 17, wherein an acceptable alternative QoS meets the requirements of the application.

29. The apparatus of claim 17, wherein the application comprises a guaranteed bit rate (GBR) application.

30. The apparatus of claim 17, wherein the first network comprises a radio access network (RAN).

31. The apparatus of claim 17, wherein the first network comprises a roaming network from the viewpoint of the client device.

32. The apparatus of claim 17, wherein the second network comprises a core network.

33. An apparatus for managing, at an application server, a quality of service (QoS) provided for an application executing on a client device, comprising:
means for receiving, from the client device, an identifier of a first network servicing the client device;
means for determining a QoS of a supplemental link established by a second network for the application;
means for determining whether or not the QoS of the supplemental link meets requirements of the application; and
means for determining whether or not the first network is able to support an alternative acceptable QoS when the QoS of the supplemental link does not meet the requirements of the application.

34. A non-transitory computer-readable medium for managing, at an application server, a quality of service (QoS) provided for an application executing on a client device, comprising:
at least one instruction to receive, from the client device, an identifier of a first network servicing the client device;
at least one instruction to determine a QoS of a supplemental link established by a second network for the application;
at least one instruction to determine whether or not the QoS of the supplemental link meets requirements of the application; and
at least one instruction to determine whether or not the first network is able to support an alternative acceptable QoS when the QoS of the supplemental link does not meet the requirements of the application.
